(19) United States
(12) Patent Application Publication
(10) Pub. No.: US 2003/0209158 A1
(43) Pub. Date: Nov. 13, 2003

(54) Continuous conditioning system and method of using same

(76) Inventor: Avi-Ben Porat, Norwalk, CT (US)

Correspondence Address: MORGAN & FINNEGAN, L.L.P., 345 Park Avenue, New York, NY, 10154-0053, US

(21) Appl. No.: 10/141,107

(22) Filed: May 7, 2002

(51) Int. Cl. B41F 35/06

(52) U.S. Cl. 101/425

(57) ABSTRACT

A continuous conditioning system for a printing belt or cylinder in a printing press includes a conditioning device and a cleaning device. The continuous conditioning system is designed to improve print quality by removing and/or significantly reducing transferability of excessive or wet ink, debris, residue or shadows from previous impressions that accumulate on a printing belt or cylinder. The conditioning device includes a conditioning cloth which is in the form of a belt that is in continuous engagement with the printing belt or cylinder. The continuous conditioning system may include a cleaning cloth which is in the form of a belt that is periodically brought in engagement with the printing belt or cylinder. The conditioning device and the cleaning device each have a cloth-rinsing/cleaning device for cleaning the conditioning cloth which is in the form of a belt and cleaning cloth which is in the form of a belt after they contact the printing belt or cylinder.

### BACKGROUND OF THE INVENTION

1. Field of the Invention

The present invention generally relates to a continuous cleaning system for use in printing operations, and more particularly to a device for continuously conditioning a printing belt or printing cylinder by treating any ink or debris that accumulates on the printing belt so that the ink or debris can not be transferred.

2. Description of Related Art

Until recently, multi-part business forms, bills, and other print-on-demand items were printed using printing cylinders. The printing of these items was limited, however, by the size and diameter of the printing cylinder, as it was necessary to change the printing cylinders in order to accommodate print patterns of various lengths.

In response to this shortcoming, a printing press having an endless closed-loop belt was developed. With the innovation of this printing belt, it is no longer necessary to stay with the same impression without making changes to the press. In the general operation of this type of printing belt, an image is transferred onto the surface of the belt, and an impression cylinder presses the paper in contact with the belt. This transfers the image to the paper.

During operation, each revolution of the belt potentially transfers the printing image to a different area of the belt. Because the same area of the printing belt does not repeatedly receive an image at the same location, ink residue or shadows from the previous impression remain on the printing belt during subsequent impressions. Through use, such ink residue accumulates on the printing belt and causes deterioration in print quality and a waste of paper. Thus, there exists a need for a method and system of continuously conditioning the printing belt to ensure that any residual ink that may be transferred to paper in successive revolutions is removed from printing belt. Such cleanup operations are also needed to remove extraneous paper, dust, debris, and other contaminants from the printing belt to improve the quality of the printed product.

The procedure that the vast majority of printing plants using endless, closed loop printing belts follow to deal with this problem is to periodically interrupt the printing process and manually clean the belt. To clean the belt, the print operator usually applies a cleaning solvent directly onto the printing belt. This solvent loosens the ink and other debris from the printing belt, so that it can be removed, either by manual scrapping or by some other means. In the past, the surface of the printing belt was wiped so that the solvent, along with the ink and other debris, could be collected in a trough or pan, or alternatively, captured by a rag or some other absorbent material. Cleanups are often neglected by the operator because the procedure is tedious, time consuming, and messy. This causes unnecessary wear of the belts and reduced life expectancy.

Following the cleaning process, the printing belt should be completely dry before printing is resumed. Complete drying of the printing belt is particularly important when the cleanup liquid is solvent, since solvent left on the printing belt will contaminate the paper and cause excessive waste when printing resumes. Similarly, excess water left on the printing belt following wash-up can disturb the ink-water balance and result in additional paper waste.

A very thin film of dry ink build-up on the printing belt does not have a substantial negative effect on print quality, as a subsequent wet image can be transferred over the dry ink. As additional ink and debris accumulate, however, the layer of dry ink may scale off the belt and degrade print quality, or adhere to the belt and make removal difficult.

The cloths or other articles used to remove the wet ink and debris from the printing belt should be clean and dry. Excessive build-up of ink or debris on the cloth used to condition the printing belt will not effectively dry the printing belt, resulting in a deterioration of print quality.

There exists a need, therefore, for a continuous conditioning system for the printing belts used in a printing press that reduces the time and effort necessary to clean the printing belt, keeps the printing belt clean and dry to prolong its life, and prevents excessive build-up of ink or debris on the printing belt and the cleaning components.

### SUMMARY OF THE INVENTION

The present invention solves these and other issues as demonstrated in the following detailed description. In one embodiment, a conditioning device is provided to continuously remove and/or significantly reducing transferability of excessive or wet ink that accumulates on a printing belt or cylinder. The conditioning system includes a constantly revolving conditioning cloth that is in continuous engagement with the printing belt or cylinder. The device is designed to improve print quality by removing and/or significantly reducing transferability of residue or shadows from previous impressions on the printing belt.

In another embodiment of this invention, the conditioning system also includes a dryer, for example, an infrared drying device, for drying the conditioning cloth before the cloth engages the printing belt. The dryer assures that the conditioning cloth can effectively absorbs excess or wet ink existing on the printing belt or cylinder.

The continuous conditioning system may further include a belt-cleaning device. The belt-cleaning device includes a cleaning cloth that periodically contacts the printing belt or cylinder to clean and scrub the printing belt, or cylinder, after each run, or at the end of each day. The belt cleaning system includes a wetting mechanism which pre-soaks the cleaning cloth with solvent, or other cleaning liquids, before it contacts the printing belt or cylinder.

In one embodiment, a cloth cleaning system for the conditioning cloth and a cloth cleaning system for the cleaning cloth of the periodic cleaning device. As described below, the system can also be configured using alternative or additional conditioning, drying, and cleaning means.

These aspects and other objects, features, and advantages of the present invention is described in the following Detailed Description which is to be read in conjunction with the accompanying drawings.

### BRIEF DESCRIPTION OF THE DRAWINGS

FIG. 1 is a perspective view of a continuous conditioning system in accordance with the present invention.

FIG. 2 is a perspective view of a continuous conditioning system in accordance with the present invention.

FIG. 3 is a perspective view of a continuous conditioning system in accordance with the present invention.

FIG. 4 is a perspective view of a continuous conditioning system in accordance with the present invention.

### DETAILED DESCRIPTION OF PREFERRED EMBODIMENTS

A continuous conditioning system for a printing belt or cylinder in a printing press generally identified by the numeral 2 includes a conditioning device 20 and a cleaning device 60. The continuous conditioning system is designed to improve print quality by removing and/or significantly reducing transferability of excessive or wet ink, debris, residue or shadows from previous impressions that accumulate on a printing belt or cylinder.

Adverting to the drawings, in which like numerals denote like components, there is illustrated a continuous conditioning system for a printing belt 10 according to the present disclosure. It is understood that the device may be employed to condition and clean several of the belts, conveyors, and cylinders in printing presses known in the art. For the sake of simplicity, the device is described as applied to the printing belt 10 of a printing press, the device being equally applicable to the other belts, conveyors, and cylinders.

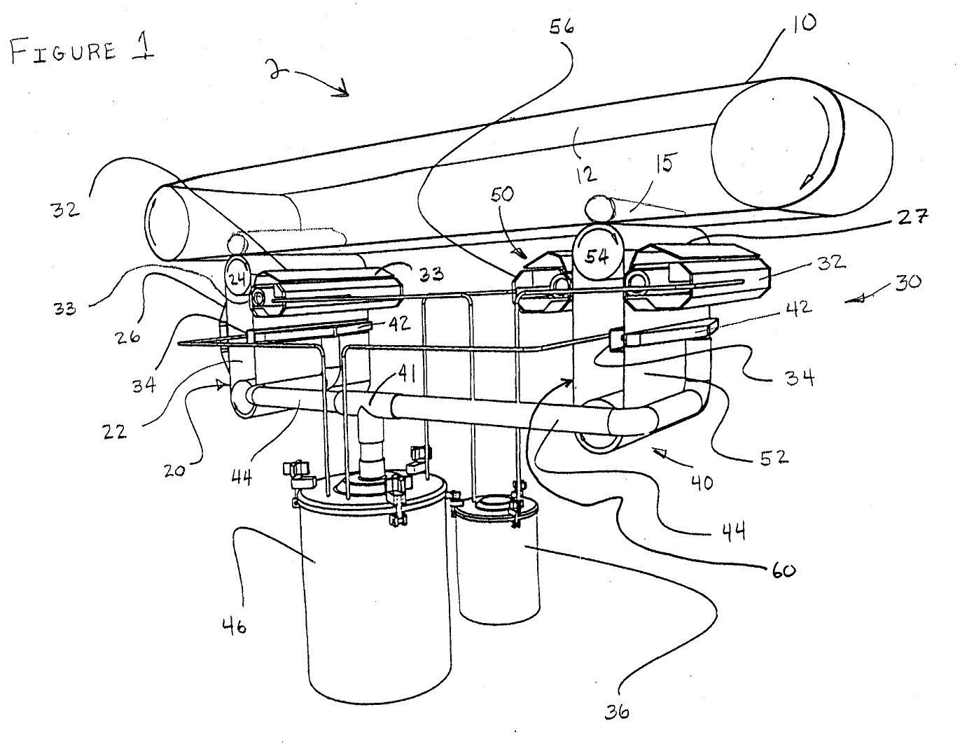

FIG. 1 illustrates a continuous conditioning device 20 and a cleaning device 60 that are positioned adjacent to a printing belt 10. Depending on the embodiment, the conditioning device includes a conditioning cloth which is in the form of a belt 22. In other embodiments, the conditioning media can be cloth if the cloth dispensing unit is used or cloth/porous-media in a form of belt. Illustrated in FIG. 1, is a belt and not a cloth. The belt may be made of a non-woven cloth and utilized as a cloth. In addition, the conditioning media may be in the form of a porous synthetic material which can absorb contaminants and liquid. The conditioning device further includes a drying device 26, and a conditioning cleaning device 27. The cleaning device comprises a cleaning cloth 52, a means for cleaning the printing belt 50, and a cleaning cloth cleaning device 30.

The conditioning belt or cloth 22 is in continuous contact with the printing belt 10 and constantly revolves about rollers 24, powered by conventional rotating means, such as an electric motor. This conditioning cloth absorbs wet ink and provides a mechanical loosening function by dislodging and facilitating the removal of accumulated dry ink or debris, which stick to the printing belt.

The conditioning device 20 in the present embodiment also includes a device to dry the conditioning cloth 26. In one implementation, the drying device is an infrared drying device. Although, it is within the scope of the present continuous conditioning system to be an air knife, a vacuum, a heating device, or some like device. The cleaning cloth is exposed to the drying means preceding contact with the printing belt, ensuring that the cloth will be dry, and consequently absorbent, when passing over the surface of the belt.

The conditioning device 20 also includes a conditioning cloth cleaning device 27 as shown in FIG. 1. The cloth cleaning device includes a wetting mechanism 32, a spray mechanism 34, and a recovery system 40. After the conditioning cloth 22 engages the printing belt, and absorbs the excess or wet ink, the conditioning cloth cleaning system cleans the cloth.

The wetting mechanism 32 dispenses detergent, or some other liquid or solid cleaner, from a detergent supply tank 36. This dilutes the ink or dissolves other debris on the conditioning cloth. Depending on the implementation, the wetting mechanism is a wetting roller 33 held in contact with the cloth and partially submerged in a detergent bath to transfer detergent onto the conditioning cloth. As the conditioning cloth revolves around the rollers 24, the wetting roller 33 rotates, causing the conditioning cloth to become saturated with detergent.

In another variant, the wetting mechanism is a means for spraying solvent, such as a spray bar, directly onto the conditioning cloth. In still another variant, a previously saturated cleaning cloth contacting the conditioning cloth can be used for purposes of the wetting mechanism.

The spray mechanism 34 includes a power spray device for pushing detergent, or other liquid, through the conditioning cloth to loosen debris. Depending on the implementation, the spray mechanism 34 directs a stream of air through the conditioning cloth. The construction and operation of a spray bar dispensing fluid can be of any form known to those skilled in the art.

The recovery system 40 consists essentially of a vacuum generation means 41, a vacuum head 42, conduit means 44, and a recovery tank 46. The vacuum generation means is attached to the vacuum head by the conduit means. The vacuum head is a substantially “U” shaped housing extending along the width of the conditioning cloth 22. Flexible wipers are positioned at the ends of the sides of the housing and thus contact the conditioning cloth to seal the surfaces and loosen debris on the cloth. It is understood by those skilled in the art that such sealing means do not have to be in contact with the conditioning cloth to provide suction; for example, another embodiment uses a labyrinth surface.

Depending on the implementation, conditioning cloth 22 may be cleaning cloth 52, which would have certain qualities to maximize its usefulness. In any implementation, the cloth should be porous in order to be absorbent to ink and solvent. The cloth should have sufficient abrasive resistance so as not to shed lint or other foreign particles, and should have sufficient mechanical tension strength to avoid breakage. The diluted ink, dissolved debris, and detergent are drawn into the vacuum head by the vacuum generating means and travel through the conduit means into the recovery tank. The spray mechanism 34 facilitates this vacuuming by loosening debris prior to suction.

As shown in FIG. 1, the spray mechanism receives solvent from the recovery tank (or supply tank 36) by means of a conduit. As has been discussed, the used solvent from the spray mechanism is captured by the recovery system into the recovery tank. Since the mixture of detergent, ink, and debris is diluted, it can be reused to clean the conditioning cloth a number of times. To extend the life of the detergent, the mixture may be filtered. Once the mixture in the recovery tank is too contaminated to use, the detergent is replaced. The recovery system reduces the environmental impact of the conditioning process.

Periodic cleaning of the printing belt is beneficial to print quality. The printing belt cleaning device 50 of this embodiment can be engaged as desired to wash the printing belt 10 in a thorough and complete manner not called for in the conditioning device 20. The belt cleaning device 60 uses a cleaning cloth 52 of the type used as a conditioning cloth specified previously.

The cleaning cloth cleaning device 30 used is identical in function and description as the aforementioned conditioning device 20. Both of these devices are connected by conduit means 44 to the vacuum means 41 evacuating to the recovery tank 46. Both of these devices function such that cloth cleaning occurs following cloth contact with the printing belt.

The printing belt cleaning device includes means to clean the belt 50. This means, in the present embodiment, is similar in function and composition as the cloth cleaning devices 27, 30. The belt-cleaning device includes wetting mechanism 56 that saturates the cleaning cloth before it is exposed to the printing belt. The saturated cloth then passes over the belt so that mechanical contact can substantially loosen and dislodge accumulated dry ink and debris. The wetting mechanism in this embodiment is a wetting roller of the type described above, but the use of other wetting means is understood from this disclosure.

The roller 54 of the cleaning cloth serve both to move the cleaning cloth into engagement with the printing belt and to cause the rotation of the cleaning cloth. Depending on the implementation, the cleaning device is retractable and moved into engagement as needed. It is understood that the same detergent supply may be used by both of the cloth cleaning means, as well as by the wetting means for the belt-cleaning device.

The conditioning device 20 and the belt cleaning device 60 should have containment or back-up rollers 15, or the like, on an opposite surface 12 of the printing belt 10. Although, this feature is not necessary for the invention to fully operate. These back-up rollers support the belt at points of contact to prevent the belt from “fluttering” during the continuous contact of the conditioning device and the periodic contact of the cleaning device. This reduces fatigue and increases the useful life of the printing belt.

The continuous cleaning system 60 for the printing belt 10 may also include a dryer, such as an air knife, positioned adjacent to the printing belt, after the conditioning device with respect to the direction of belt rotation. The drying means is to remove any residual moisture not removed during the conditioning procedure.

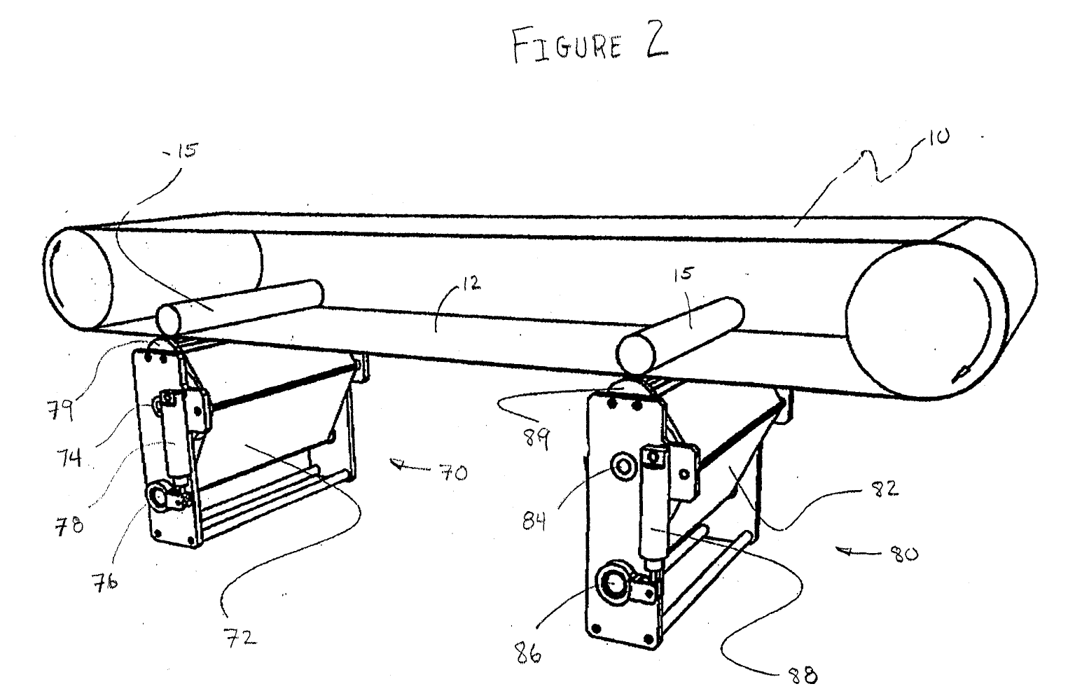

FIG. 2 illustrates a conditioning system in the form of cloth dispensing unit and in which the cloths used to clean and condition the printing belt 10 are wound on rolls. In FIG. 1, for comparison, the cloth was in the form of a belt. Shown in FIG. 2, a continuous conditioning device 70 and a cleaning device 80 are positioned adjacent to a printing belt 10.

The conditioning device is composed of a conditioning cloth supply roll 74, a conditioning cloth 72, a conditioning cloth take-up roll 76, a means for advancing the conditioning cloth 78, and a cloth engaging device which is in a form of inflatable bladder or a mechanism that moves the system to contact the printing belt (Trade name IMPACT®) 79 for engaging the cloth to the printing belt.

The conditioning cloth is mounted on the conditioning cloth supply roll 74 such that it passes between the IMPACT® 79 and the printing belt 10, and is attached to the take-up roll. The means for advancing the cloth 78 is mounted in such a way as to actuate the rotation of the take-up roll. The fabric, properties, and construction of the conditioning cloth 72 are identical to the conditioning belt for the conditioning device in FIG. 1. In addition, the cloth should provide lint resistance. One such example of a suitable cleaning cloth is that sold by Baldwin under the trade name Printmaster®, made by DuPont, which is a nonwoven polyester composition spunlaced fabric. The nonwoven fabric is formed by a hydroentangling process in which staple fibers are entangled through “hydraulic needling” to form a strong, fabric-like structure.

Also shown in FIG. 2 is an example of the IMPACT® 79, which in this illustration is an inflatable bladder. By pneumatically inflating or expanding the bladder in some other way, the surface of the bladder contacting the conditioning cloth 72 will move the conditioning cloth 72 into engagement with the surface of the printing belt 10 to thereby dry the same.

The use of an inflatable bladder provides a relatively wide and uniform stripe along the printing belt 10 which substantially eliminates the presence of streaks on the belt after conditioning. Furthermore, the bladder is not easily contaminated with ink and is cleaned much easier than a brush, or the like, having bristles. The use of a flexible bladder also provides a mechanical cleaning means or scrubbing means to loosen debris on the printing belt while cleaning the printing belt.

Further information about the construction and operation of an inflatable bladder as a means for moving a cleaning cloth into engagement with the surface of a cylinder is set forth in U.S. Pat. No. 4,344,361 dated Aug. 17, 1982 to Macphee et al., and its continuation, U.S. Pat. No. 4,757,763 dated Jul. 19, 1988, for an Automatic Blanket Cylinder Cleaner, which is incorporated herein by this reference. Depending on the implementation, the IMPACT® may be in the form of pivotable blades or moveable rollers.

Further illustrated in FIG. 2 is means for advancing 78 the conditioning cloth 72 onto the take-up roll 76. In the present example, the conditioning cloth advancing means 78 includes a solenoid activated by a control mechanism that, in turn, activates a lever which turns the take-up roll 76. More information describing this advancing means are set forth in U.S. Pat. No. 5,176,080 issued Jan. 5, 1993 for a Cloth Supply System For Blanket Cylinder For Use in Printing Presses, which is incorporated herein by reference.

Depending on the implementation, the advancing means 78 is a motorized one-way clutch mechanism. Further information about the construction and operation of a suitable one-way clutch mechanism is set forth in U.S. Pat. No. 4,344,361, issued Aug. 17, 1982, to Macphee et al., and its continuation, U.S. Pat. No. 4,757,763, issued Jul. 19, 1988, for an Automatic Blanket Cylinder Cleaner, which are incorporated herein by reference. The take-up roll, in this example, is wound to accept used conditioning cloth as needed.

Depending on the implementation, the conditioning cloth 72 advances in discrete intervals during press operation. The IMPACT® 78 holds a portion of the cloth in engagement with the printing belt until the engaged portion of the cloth is no longer able to remove wet ink, at which point the IMPACT® retracts, the cloth advances to provide a clean surface to contact the belt, and the IMPACT® moves back into engagement. In another variant, the IMPACT® is held in contact with the belt while advancing the conditioning cloth.

The embodiment illustrated in FIG. 2 also include a belt cleaning device 80 similarly constructed to the conditioning device 70 as described above. The belt cleaning device 80 includes a cleaning cloth 82, a cleaning cloth supply roll 84, a cleaning cloth take-up roll 86, means for advancing 88 the cleaning cloth onto the take-up roll 86, and an IMPACT® 89, means for moving the cleaning cloth into engagement with the printing belt.

The fabric, construction, and properties of the cleaning cloth 82 are similar to the conditioning cloth 72 for the conditioning device 70 described earlier in this embodiment. The cleaning cloth, however, is treated with a solvent prior to installation on the press. This solvent treatment may be performed prior to purchase of the supply roll, or on the site of the press. Additionally, the cloth may be treated in the cleaning device 80. Cleaning cloth supply roll 84 provides the cleaning cloth 82 to the cleaning cloth take-up roll 86.

The belt-cleaning device 80 may also include means for advancing 88 the cleaning cloth 82 onto the take-up roll 86. The means for advancing 88 the cleaning cloth 82 onto the take-up roll 86 is preferably a solenoid activated by a control mechanism that, in turn, activates a lever which turns the take-up roll 86 as previously described. Although, means 88 may also include a motorized one-way clutch mechanism, a step motor, a rivet and pawl mechanism, or other motor and the like.

The cleaning cloth 82 cleanses the printing belt 10 of ink and debris when engaged by the IMPACT®. When the cleaning cloth 82 is saturated with ink or other debris, the advancing means 88 is activated to advance the cleaning cloth onto the take-up roll 86 to provide a clean portion of the cleaning cloth to contact the printing belt 10.

The belt cleaning device 80 also includes means for moving 89 the cleaning cloth 82 into engagement with the printing belt 10. The means for moving 89 the cleaning cloth 82 into engagement with the printing belt 10 is preferably an inflatable bladder as described above with the conditioning device 70, although in alternate embodiments it is a pivotable blade or moveable roller.

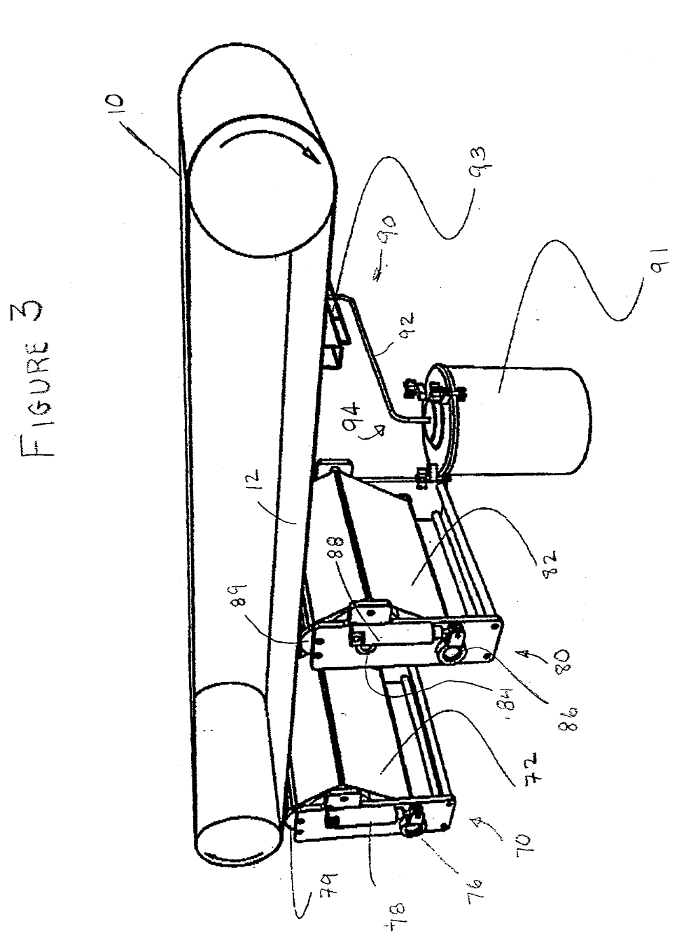

As shown in FIG. 3, a power wash system 90 may be included in the continuous conditioning system. In one example, the power wash system 90 dispenses solvent from a solvent dispensing tank 91 by conduit means 92 directly onto the printing belt 10. Operation is effected by fluid control devices 93 that direct solvent, water, or other cleaning liquids or solids, or air to spray in specific quantities and at specific pressures.

The power wash system 90 includes a recovery system 94, similar to the recovery system used in the cloth cleaning system described above, having a containment mechanism and vacuuming means to prevent the solvent from leaking into the other areas of the printing press, thereby avoiding mechanical or other damage.

Further information about a power wash system is set forth in U.S. Pat. No. 5,189,959 to Gasparrini et al., issued Mar. 2, 1993, for a Spray Blanket Cleaning System, herein incorporated by reference.

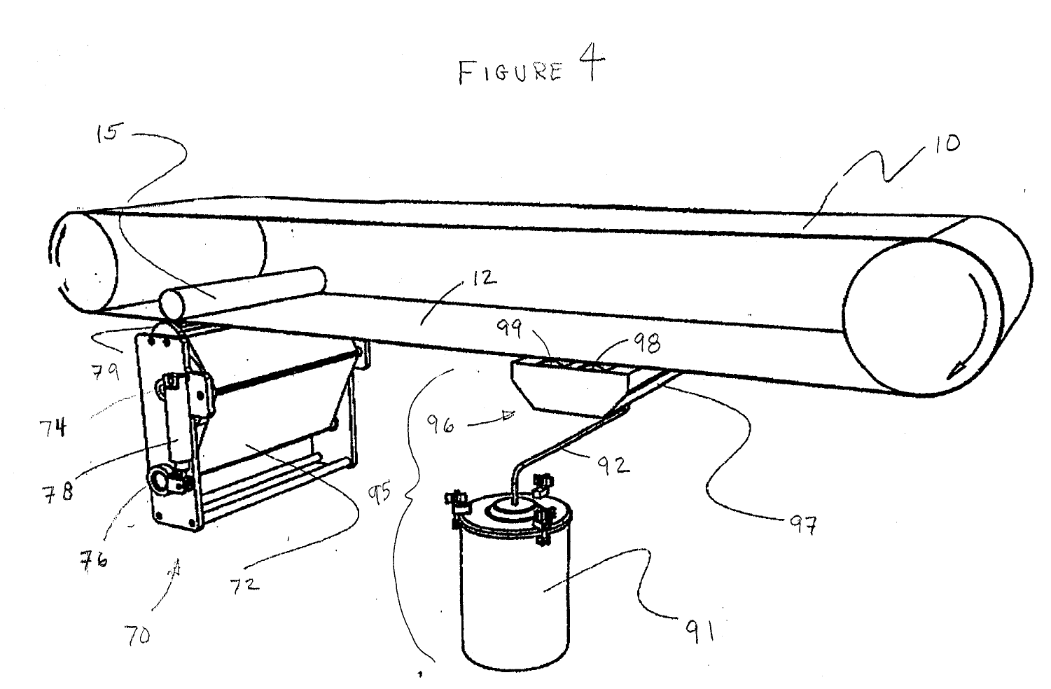

Adverting to FIG. 4, shown is a belt-cleaning device of the continuous conditioning and periodic cleaning system of a printing belt 10. The periodic belt-cleaning device 95 in FIG. 4 includes a wet/dry cleaning mechanism 96. The wet/dry mechanism 96 supplies cleaning solvent or other cleaning liquids or solids directly onto the belt 10 during the periodic washing operation.

The wet/dry mechanism 96 includes a casing 97 housing two rollers 98, 99. The housing is movable, by conventional means such as a motor, to bring the rollers 98, 99 into contact with the printing belt 10. The first roller 98 wets or soaks the printing belt 10 with solvent or other cleaning liquid. The roller 98 is partially submerged in a solvent reservoir to transfer the solvent from a solvent bath to the printing belt 10. The second roller 99 is used as a scrubbing means to rub debris or other contaminates off the printing belt. The second roller 99 can also be used to dry the printing belt but the cloth dispensing unit 70 shall be used to dry the printing belt.

It will be understood by those skilled in the art that the housing 97 for the wet/dry mechanism may contain a power wash system, as described above, and a drying means, as an adjacent infrared dryer or air knife to dry the printing belt in place of a drying roller.

It is also understood that the above description is only representative of illustrative examples of embodiments and implementations. For the reader's convenience, the above description has focused on a representative sample of all possible embodiments, a sample that teaches the principles of the invention. Other embodiments may result from a different combination of portions of different embodiments. The description has not attempted to exhaustively enumerate all possible variations.

Alternate embodiments may not have been presented for a specific portion of the invention. Some alternate embodiments may result from a different combination of described portions, or other undescribed alternate embodiments may be available for a portion. This is not to be considered a disclaimer of those alternate embodiments. It is recognized that many of those undescribed embodiments are within the literal scope of the following claims, and others are equivalent.

What is claimed is:

1. A conditioning system for cleaning a printing press component, the system comprising:
a conditioning device having a revolving conditioning cloth which is in the form of a belt in continuous engagement with the printing press component such that print quality is improved by reducing transferability of a medium from previous impressions accumulated on the printing press component.

2. The conditioning system of claim 1, wherein the medium is ink, debris made by impressions, debris from external sources, residue, shadows, or any combinations thereof.

3. The conditioning system according to claim 1 wherein the conditioning cloth is constantly revolving in a direction opposite that of the component.

4. The conditioning system according to claim 1 wherein the conditioning device includes a dryer for drying the conditioning cloth before the conditioning cloth engages the component.

5. The conditioning system according to claim 4 wherein the dryer is an infrared dryer.

6. The conditioning system according to claim 4 wherein the dryer is an air knife.

7. The conditioning system according to claim 1 wherein the component is a printing belt.

8. A system for removing transferable ink and debris from a component of a printing press, the system comprising:
a loop of conditioning cloth which is in the form of a belt held in constant contact with the component;
a cleaning device for removing ink and debris from the loop of conditioning cloth;
a drying device to ensure that the cloth is dry and absorbent before the cloth contacts the component; and
a device for rotating the cloth such that the component is engaged following application of the drying device.

9. The conditioning system according to claim 8 wherein the drying device is an infrared dryer.

10. The conditioning system according to claim 8 wherein the dryer is an air knife.

11. The conditioning system according to claim 8 wherein the component is a printing belt.

12. The conditioning system according to claim 8 wherein the cloth revolves throughout the cleaning process.

13. The conditioning system according to claim 8 wherein the system includes a cleaning device for cleaning the component.

14. A system for removing transferable ink and debris from a component of a printing press, the system comprising:
a conditioning cloth which is in the form of a belt;
a conditioning cloth supply roll;
a conditioning cloth take-up roll;
means for advancing the conditioning cloth onto the take-up roll; and
means for bringing the cloth into contact with the component.

15. The conditioning system according to claim 14 wherein the component is a printing belt.

16. The conditioning system according to claim 14 wherein means for bringing the cloth into contact with the component is disengaged to advance the cloth.

17. The conditioning system according to claim 14 wherein the system has a device to clean the component.

18. A method for removing transerfable ink and debris from a component of a printing press, comprising:
exposing a conditioning cloth which is in the form of a belt to the component; and
advancing the cloth to ensure maximum absorbency of a part of the cloth currently contacting the component.

19. The method according to claim 18 further comprising cleaning part of the conditioning cloth following exposure to the component.

20. The method according to claim 19 further comprising drying part of the conditioning cloth prior to exposing the part to the component.

21. The conditioning method according to claim 18 wherein the conditioning cloth is in the form of a loop.

22. The conditioning method according to claim 18 wherein the conditioning cloth is affixed to a take-up roll.
